(19) United States
(12) Patent Application Publication
(10) Pub. No.: US 2025/0386806 A1
(43) Pub. Date: Dec. 25, 2025

(54) SYSTEM FOR THE MARITIME TRANSPORT OF BEES

(71) Applicant: c/o Universidad Mayor, Santiago (CL)

(72) Inventors: Juan Anibal VELOZO SOTO, Santiago (CL); Alexis Rene VEGA MOREND, Cachapoal (CL); Ariel Esteban ROJAS ROJAS, Santiago (CL); Carlos Daniel IBARBE ALCAYAGA, Santiago (CL)

(73) Assignee: c/o Universidad Mayor, Santiago (CL)

(21) Appl. No.: 19/305,407

(22) Filed: Aug. 20, 2025

Related U.S. Application Data
(63) Continuation of application No. PCT/CL2023/050070, filed on Aug. 4, 2023.

(51) Int. Cl. A01K 49/00; A01K 47/06; A01K 53/00; B65D 85/50

(52) U.S. Cl. CPC A01K 49/00; A01K 47/06; A01K 53/00; B65D 85/50

(57) ABSTRACT

A system and method for transporting bees allows live bees, in hibernation, to be exported by sea. The system has a packaging device having a box with a funnel through which the bees fall and are collected, a transport box having a body, a cover of the same geometry and larger than the body to cover the side walls and top of the body, ventilation openings arranged in two of the side walls, and at least one floor arranged to cover a lower part of the body. The body is where bees are collected and a feeder is located at an opening of the body and contains gelled food. An interior space houses the bees and allows them to feed from the perimeter of the feeder, where the gelatinized food is located, and at least one refrigerated container where the transport boxes, previously palletized, are arranged for maritime transport.

### CROSS REFERENCE TO RELATED APPLICATIONS

This application is a continuation of International Application No. PCT/CL2023/050070, filed Aug. 4, 2023, the entire contents of which are incorporated by reference herein.

### FIELD OF THE INVENTION

The present invention belongs to the beekeeping industry and, in particular, it relates to a bee transport system that allows the export of live bees, in hibernation, by sea, with the aim of meeting the demand of international markets.

### BACKGROUND

Currently, the beekeeping industry has found it necessary to transport live bees in order to meet demand in various markets. One of the problems with this type of transport is the effect that long-distance transport can have on the behavior and life of bees. The transport currently used is by air. Studies on the transport of bees in traditional air transport boxes have determined that, if these boxes are used in simulated refrigerated sea transport in a container at low temperatures, the large heat exchange surface area of these boxes, combined with the refrigeration system used in this transport system, causes the bees to go into shock and begin to die shortly thereafter.

In accordance with the state of the art, attempts have been made to find solutions that allow bees to be transported for a relatively long period of time. In this regard, document CN207589846 discloses a queen bee transport box suitable for long-term transport, comprising a box body, a lid, a nest structure, and a plurality of feeding tubes, where one side of the box body is provided with a circular hole for installing a feeding tube in the box body. The other two opposite sides and the lid are provided with ventilation holes, and the nest structure is fixed to the bottom of the box body, and each feeding tube contains water, pollen, refined sugar, and honey, and the feeding tube is located in the box body. The survival rate of bees is between 2-10 days.

Another solution is presented by document CN212629556, which describes a bee breeding device that is easy to transport. The device includes a box body with a cover plate and is characterized in that the box body includes a bottom plate, a side plate, a front plate, and a rear plate on both sides of the bottom plate. A side plate slot is provided to insert the side plate and allow it to slide freely; the side plate is divided into several side plate units, and the adjacent side plate units are connected by a box extension net. The cover plate is divided into the same several cover units, and the adjacent cover units are connected by a cover extension net; the box extension net and the cover extension net are air-permeable nets that prevent the passage of bees; the side plate comprises a bottom plate fixing device, which is used to fix the side plate when it slides into place. An anti-sway connection device is also included, which includes a first stepped groove, a connection frame, a connection box, a spring, and a splint. The first stepped slot is opened in the box body, and the connection box passes through the first stepped slot connected to the box body. The spring and splint are arranged in the connection box, one end of the spring is fixedly connected to the connection box, and the other end is fixedly connected to the splint, and the splint can be installed in the connection box. The connection box slides radially, and the two legs of the connection frame are inserted respectively next to the splints in the connection boxes of two adjacent boxes.

The document U.S. Pat. No. 8,475,227 refers to a bee feeder assembly comprising: (a) a container defining an interior and having a bottom; a side wall having a lower end coupled to the bottom; and an open top; (b) a cover member positioned over the open top to close the receptacle; (i) the cover member including at least one circular bee transport opening; (c) an internal bee ladder arrangement positioned within the interior of the receptacle and hanging downwardly from the cover member; (i) the inner bee ladder arrangement comprises at least one bee ladder comprising a plastic mesh having a porous side wall surrounding a hollow interior; the side wall having at least one bee ladder in a portion surrounding the hollow interior; (A) a first lower end of at least one bee ladder comprising a portion of mesh deformed inwardly to define a lower end section of the porous side wall that is porous in a portion that narrows toward a closed lower edge; and, (B) a second upper end of at least one bee ladder having a generally circular cross-sectional shape and comprising an open end; (C) the pores in the side wall and the first end of the at least one bee ladder are sufficiently small to prevent bees from passing therethrough into the interior of the receptacle and the exterior of the inner ladder arrangement; and (D) the at least one bee ladder is sufficiently long to abut the lowermost in r part of the receptacle and extend to a location adjacent and separate from the lower end of the side wall such that a bee in the hollow interior of the at least one bee ladder can access the liquid having a liquid level near the bottom of the receptacle; (ii) the at least one bee ladder is positioned to hang down from the at least one bee transport opening such that: (A) a bee entering the bee transport opening can pass through the open end of the at least one bee ladder to a location surrounded by the side wall of the bee ladder, and is prevented from exiting the interior of the bee ladder by the pore size in the side wall, except through the open end; and (B) the side wall of at least one bee ladder does not contact the side wall of the receptacle, so that bees cannot reach the side wall of the receptacle from the bee transport opening.

However, the proposed solutions are still inadequate for transporting bees over long periods, such as more than 20 days. Therefore, there is a need to implement a bee transport system with technical parameters that allow bees to remain alive for 25 days, the period necessary to reach their destination markets.

### SUMMARY

The present disclosure seeks a design for a shipping box with parameters for feeding, temperature, insulation, and air flow that allow bees to remain alive for up to 25 days, the time necessary to reach their destination markets. This disclosure provides a system that not only involves transport by sea, but also the packaging of the bees themselves, which then generates a hibernation cake in which they remain alive until their final location. Packaging is carried out using the method described in point 6, transferring the bees to these innovative boxes designed for transport, ensuring that mortality does not exceed 5% of the total during the entire process, i.e., ensuring the survival of over 95% of the bees.

The following components and transport conditions are contemplated in the context of the system described:

Box or container design: The boxes are square in shape, a design that has proven to offer greater structural strength, stability, and ease of construction.

Noise: The structure of the box itself is a good acoustic insulator, reducing the noise level to around 10 dB compared to the ambient noise inside the container. It was determined that at noise levels of 90-92 dB, the bees show no signs of stress.

Air flow and insulation system: Air flow is reduced to almost zero by installing boards on the floor of the container. This allows a small return breeze to enter the boxes, but not the main high-speed air flow, improving the thermal control capacity of the bee cluster.

Temperature and relative humidity ranges: The ambient temperature of the container to induce hibernation behavior must be below 8° C. At this temperature or higher, bees become very active, with high food consumption and stress due to confinement. The range of temperatures at which bees can be kept for 25 days has been established (4-7° C., with relative humidity of 65%).

Feeding: The composition of the food provided during the cold period is critical to the success of the system. Bees were found to consume sugar-based foods faster than complete foods containing proteins, amino acids, and vitamins. Sugar-based foods without protein were shown to increase bee viability and extend the hibernation period to 35 days. The 25-day captivity period implies a food consumption rate of 120 g per day. The solution to this food demand was to create a feeder that provides 5 to 6 liters of gelatinized food.

Gas concentration: The system should tend to maintain the atmospheric concentration of CO2 and O2 so that the bees can maintain adequate metabolic activity, ensuring the viability of the hibernation cake.

Packaging method: The best packaging alternative identified is a modification of traditional packaging. The technique developed involves the use of a breeding chamber with a metal loading funnel at the bottom. This assembly is fixed to a metal structure with a wheel and trolley handles. The metal structure also has a height-adjustable base platform, to which a commercial scale with a capacity of 20-30 kg and a sensitivity of 1 g is attached. The box to be loaded with bees is placed on the scale so that it can be adjusted to the weights of bees required by the market.

Release from hibernation: Once at their destination (in spring), the bees are transferred to brood chambers or nucleus boxes, where they emerge from hibernation induced by the ambient temperature. Once in the definite apiary, the bees can survive as nuclei, regaining their activity as functional colonies within the production parameters.

A square box design has been determined to be the best alternative among those tested: it has a large surface area for gas and heat exchange, but with a corrugated cardboard cover with small, fixed openings for gas and heat exchange, the heat exchange rate is regulated. This model allows the bees to remain in hibernation, achieving a balance between heat loss, which induces hibernation, and the ability of the nucleus or cluster of bees to generate heat.

Food also plays an important role. Advances indicate that food containing protein should not be given to bees because it causes mortality problems when they are in captivity. Since all bees in a package are adults, they already have the necessary protein and lipid reserves, at least for the duration of the trip. For long trips (more than 20 days), the main components of the food are water, carbohydrates (mainly sucrose), and agar as a gelling agent. Antioxidants, acidifiers to adjust the pH, and a preserving agent are also required in smaller proportions. The daily consumption rate of this food is around 80-120 g, which increases if the ambient temperature of the container is 8° C. or higher. The average feed consumption rate, combined with a feeder with an effective feed volume of 5-6 liters, allows the bees inside the transport box to be self-sufficient for about 25 days. The box is designed to hold a 6-8 liter feeder, of which 5-6 liters are for gelled food.

For collecting bees, the system comprises a rectangular metal structure with a breeding chamber attached to the top, without a roof or cover, which has a metal funnel attached to its base. The diameter of the funnel tube is slightly smaller than the diameter of the body (21) of the transport box (20), so that the former can overlap well and the bees can fall directly into the body (21) of the transport box (20). The body (21) is placed on an electronic scale that is fixed to a platform that can move vertically, in order to adjust the overlap of the funnel with the box. To bring the bees to the funnel, frames with bees are collected from the donor hives, after removing the queen (which is placed in a cage). The bees are sprayed with drinking water using an atomizer and then the frame is shaken inside the breeding chamber (11) with funnel (12), taking care that no nectar falls on the bees or the surfaces of the funnel. The bees will fall into the body of the transport box (14, 21) without any bees escaping. The bees are loaded until the desired weight is reached according to the market and the weight of live bees required at the destination, based on the expected mortality rate. The weight of the bees is determined with an electronic scale (15) attached to a base (16) that can be adjusted in height, which is fixed to the metal structure (13) and whose function is to lift the scale assembly (15) and the body of the transport box (14) until the box overlaps the funnel (12), facilitating the fall of bees into the box (14). Once the desired weight of bees is reached, the transport box is removed from the loading structure and the queen is released inside, immediately placing the feeder in the upper opening (25) of the transport box body (14, 21), sealing the upper part of the box.

### BRIEF DESCRIPTION OF THE DRAWING

FIG. 1 shows a diagram of the system and method for transporting bees by sea, in accordance with this disclosure.

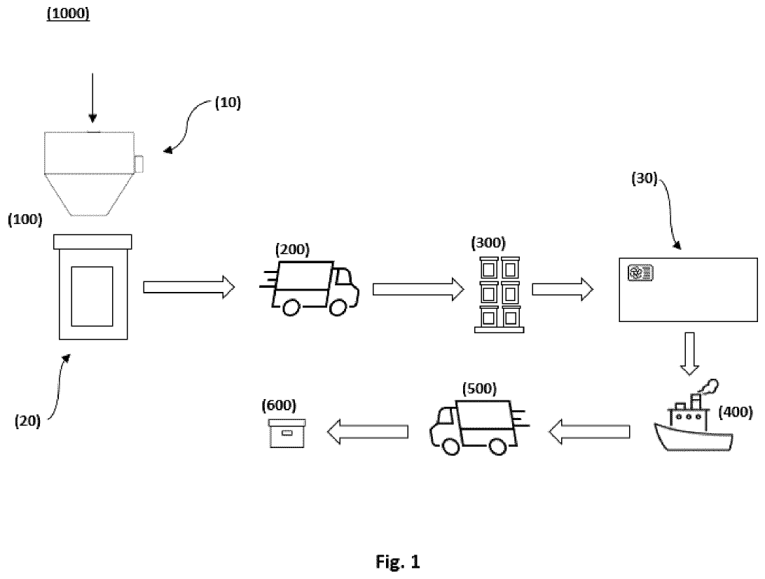

FIG. 2 shows a diagram of a packaging device, in accordance with this disclosure.

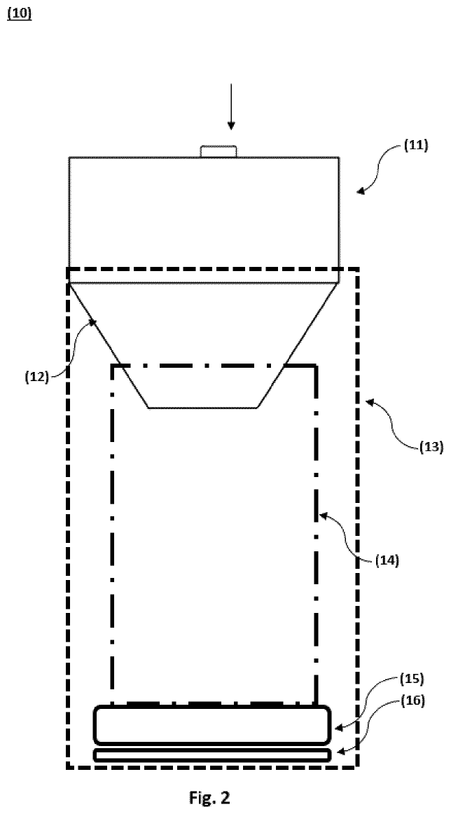

FIG. 3 shows a perspective view of a square transport box, in accordance with this disclosure.

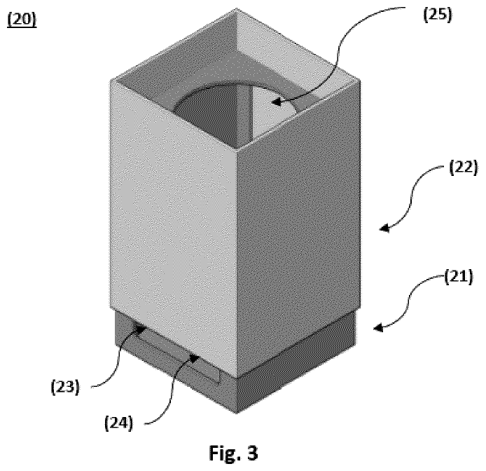

### DETAILED DESCRIPTION

The present disclosure relates to a system (1000) and method for transporting bees that allows the export of live bees, in hibernation, by sea.

In the first stage, the packaging of the bees (100) is defined. To carry out this stage, the honeycombs with bees are removed one by one from a hive. Each honeycomb is sprayed with water to wet the bees' wings and reduce their possible loss by flight. The comb is taken to a packaging device (10) consisting of a loading hopper comprising at least one wooden box from a brood chamber (11) and a tin funnel (12), both attached to a metal structure (13) with a pneumatic wheel and wheelbarrow handles for easy transport in the field. The honeycomb with bees sprayed with water is placed inside the wooden box (11), held by its upper ends and shaken vertically so that the bees fall into the funnel (12) and from there into the body of the transport box (14 and 21). Usually, 6 to 8 frames with bees are required to obtain approximately 1 kg of bees, which is the amount required for a package of bees.

The transport box (20) consists of a body (21) and a cover (22) that is separated from the body by 3 mm on all sides, allowing air to flow by convection. The cover (22) has the same geometry and larger dimensions than the body (21), including a roof, which limits heat loss from the body (21) and completely covers all the side walls of the body (21). The body (21) has two ventilation openings (23) arranged on two opposite side walls of the body (21) at its base, which are delimited by ventilation meshes of 300 cm2 each (24). The body of the transport box (21) is open at the top (25) to receive the feeder, which is 19 cm in diameter and 30 to 43 cm high, which seals the top of the transport box body (21). This feeder has a central cylindrical space 12 cm in diameter, delimited by a plastic mesh allowing the bees to pass through to the gelled food located around the periphery. The peripheral space is open towards the central space of the feeder so that the bees can access the food. At the top, the feeder has a lid with 36 holes 3 mm in diameter to create a convection air flow that facilitates the release of heat, humidity, and gases in a proportion allowing the bees to regulate the temperature and relative humidity of the interior of the transport box (21). At the same time, in the central part of the feeder lid facing the central space, there are three guides measuring 4×0.5×0.3 cm, separated by 4 cm, so that the bees can start forming their honeycombs there. When the feeder lid is placed on top, a 5×40 cm Raschell mesh is trapped between the lid and the body of the feeder, allowing the bees to climb up to the food and to create one to three wax combs from the guides.

The body (21) of the transport box has a large surface area for gas and heat exchange, but with a corrugated cardboard cover (22) with small, fixed exchange openings. This model allows the bees to remain in hibernation at temperatures of 4-7° C. and 65% relative humidity.

It has been determined that the food to be supplied should be based on carbohydrates (sugar), an antioxidant, a preservative, an organic acid to adjust the pH (4.5 to 5.5), and agar as a gelling agent. With this formulation, the bees have a food consumption rate that allows for 25 days of refrigerated transport when the feeder has a capacity to hold 5-6 liters of gelled food.

For land transport (200), the bodies (21) of the bee transport boxes must be carried in closed trucks to prevent direct wind from hitting the bodies of the boxes. If this happens, the bees may die because they are unable to compensate for the rapid heat loss caused by the wind, especially if transport takes place at night. If refrigerated trucks are used, they must maintain a temperature of around 15° C. and keep the CO2 concentration at atmospheric levels.

Once the bodies (21) of the boxes have arrived at the collection point (300), the covers (22) are placed on the bodies (21) of the transport boxes, which are then palletized (300), leaving a 4 cm gap between the transport boxes (20) along a row of boxes (20) and 10 cm between rows to allow air to circulate between them, but arranged so that the wind from the container is parallel to the ventilation mesh of the boxes. Given the design of the box, a pallet contains 60 boxes.

The pallets with the transport boxes (20) already secured with corner pieces must then be placed in a refrigerated container (30), arranged in such a way as to ensure that all the transport boxes (20) have similar environmental conditions and especially the air flow from the container fans (30). Due to the amount of heat generated by the bees, it is expected that a container cannot be filled with pallets containing bee transport boxes (20). The bee transport boxes (20) do not require any special procedure for the bees to enter hibernation mode (compact cluster with low bee activity). To achieve this, simply expose the transport boxes (20) to the recommended temperature and within 5 to 10 minutes, the bees will form the hibernation cake. The same applies when the cold weather ends, with the bees resuming their normal level of activity after 10 to 30 minutes of exposure to field conditions. The variables to be controlled in the container are temperature, relative humidity, O2 and CO2 concentrations, and wind speed incident on the transport boxes (20). The noise inside the container (30) does not need to be controlled if it is around 90 dB or less.

The transport temperature should be set in the container within the range of 4 to 7° C. Bees control the temperature of the cake and, by extension, indirectly that of their living space, provided they have free access to food and that it contains a high concentration of sugars and is in a quantity adequate for the autonomy required for transport to their destination.

Relative humidity should be maintained at around 65%. Bees also have the ability to control relative humidity within a certain range, reducing fluctuations in the container environment. As with temperature, access to and quality of food is important for bees to maintain this control ability.

Bees require O2 and CO2 to be at normal atmospheric concentrations. To achieve this, regular ventilation of the container (30) must be programmed and/or an electronic controller independent of the container control system (30) must be provided allowing to regulate the concentration of these gases in the container atmosphere. In both cases, the basic control is to reduce the concentration of CO2 produced by the bees' respiration and increase the concentration of O2 consumed for the same reason, which is achieved simply by ventilating the container (30) at regular intervals through its vents, maintaining the recommended temperature and relative humidity.

As previously indicated, the noise inside the container (30) should not exceed 90 dB, which is not a concern in newly manufactured containers. In older containers, it may be necessary to reduce the noise by a few decibels with pressed wood panels positioned on the container wall covering the fans.

The wind generated by the fans inside the container (30) is not a cause for concern if the box is designed to withstand the incident wind speed, which could be up to 0.5 m/see with the current box design (20). The box cover (22) is placed on top of the box at the time of palletizing, where its ventilation slots must be parallel to the ventilation meshes of the box (24) and to the direction of the wind inside the container (30), preventing the heat exchange surfaces of the transport box (20) facing the wind directly. The incidence of wind can be controlled by installing deflectors inside the container (30).

During maritime transport (400), given the capabilities of today's refrigerated containers, it is possible to program the container's refrigeration system (30) to maintain the ideal temperature and relative humidity for the bees, without the need to intervene or open the device until the health inspection at the destination and/or at the destination apiary. In addition, they also have the ability to exchange air with the outside to maintain CO2 and O2 concentrations within the appropriate ranges for bees, which is a mandatory requirement to ensure the viability of the bees or, alternatively, to use atmosphere control technology to maintain these concentrations at the appropriate levels. Thus, the cooling conditions in the container (30) must be programmed when the palletized boxes are loaded into the container.

Once at the port of discharge, the goods are transported by land to their destination (500). Since there is unused space in the container (30), the cargo must be stowed correctly, taking into account both the container's center of gravity (30) and the air flow between the pallets (300). It is important to use sanitary-certified wooden structures to secure the load and prevent the pallets from moving during transport (30). If the container is self-contained, it can transport the load to the destination apiary without any problems. If returning the container from its destination is not possible or if it is not self-contained, the pallets with the transport boxes (20) containing the bees must be taken to their final destination from the port of arrival by closed trucks, ideally refrigerated, taking care to maintain the atmospheric conditions indicated above. For a closed truck, especially if it does not have refrigeration equipment, the bodies (21) of the transport box must be without the cover (22) and cannot be loaded to full capacity to prevent the bees from overheating as the heat they produce cannot be dissipated properly. Similarly, the transport box bodies (21) cannot be transported to their destination exposed to the air in an open truck.

Bees are highly adaptable and respond well to exposure to the cold in a natural environment, especially in spring. The aspects to consider would be the same as for conventional land transport of nuclei: the pallets with bee packages are unloaded from the refrigerated container or truck at their destination. The pallets must be dismantled immediately, and the cover (22) of the transport box (20) must be removed and discarded to allow the bees to ventilate, dissipate heat, and exchange gases. Once the transport boxes (20) have been unloaded, the bees must be quickly transferred to the breeding chambers or nucleus boxes and fed syrup to recover from the transport process. Once on site (600), the feeders are removed from the transport boxes (21) and left inside the brood chamber that will receive the bees, allowing the bees to exit and take possession of their new space. The bees that remain in the body (21) of the transport box (21) are sprayed with water to prevent them from flying away and then shaken so that they fall into the brood chamber, after which the roof is placed on the brood chamber. It is recommended that the brood chamber receiving the bees have one or two frames with capped brood and one frame with food (honey and pollen), which will serve as a start for the new colony in the apiary, plus one frame of stretched wax.

After one or two days, the feeder is removed from the hive and health checks are carried out to check the condition of the colony. One week after unloading, the activity of the colony should be inspected, especially the position of the queen and the accumulation of nectar, along with new health checks, which should be repeated regularly as part of standard apiary management.

What is claimed is:

1. A bee transport system (1000) that allows the export of live bees in hibernation by sea comprising:
a. a packaging device (10) comprising a brood chamber box (11), connected to a collection hopper (12) through which the bees fall into a transport box (20);
b. a transport box (20) comprising a body (21), a cover (22) of the same geometry and larger than the body (21) to cover all the side walls and roof of the body (21), with two ventilation openings (23) arranged on two opposite side walls of the body (21), at least one floor (24) arranged to cover the bottom of the transport box (20), said body (21) being where the bees are collected; and
c. a refrigerated container (30) where the transport boxes (20), previously palletized, are arranged for maritime transport.

2. The system (1000) of claim 1, wherein the transport box (20) comprises a square cross section, formed by the body (21) and the cover (22), where the body (21) comprises two ventilation openings (23), arranged opposite each other, and at the top of the body (21) there is an opening (25) for placing a feeder.

3. The system (1000) of claim 1, wherein once at the packaging location, the body (21) of the transport boxes, with their respective covers (22), are palletized with a separation distance between the boxes (20) of 4 cm along a row of boxes and 10 cm between the rows of boxes (20) to allow air movement between them, arranged in 3 tiers of boxes with 20 boxes per tier.

4. A method of transporting bees that allows the export of live bees in hibernation by sea using the system of claim 1, the method comprising:
a. packing the bees into the body (21) of the transport box which is placed under the packing device (10), where the bees fall by gravity through a collection hopper (12);
b. placing a food dispenser in the box;
c. transporting the bodies of the transport boxes (21) to a palletizing location;
d. covering the body of the transport box (21) with the cover (22);
e. palletizing the transport boxes (20), with space between the transport box packages (20);
f. loading the pallets with transport boxes (20) into a refrigerated container (30) to maintain temperature and relative humidity conditions during transport;
g. transporting the transport boxes (20) from a port of origin to the port of destination; and
h. emptying the bees from the transport box bodies (21) into nucleus hives or breeding chambers so that the bees can settle into the new space.

5. The method of transporting bees of claim 4, wherein, in the packaging stage, a food dispenser is placed in the transport box, which has a space for the food and another for the bees.

6. The method of transporting bees of claim 5, wherein the food is a gelled food with sugar, preserving agent, antioxidant, with a pH between 4.5 and 5.5.

7. The method of transporting bees of claim 6, wherein the food dispenser has a volume of 6 to 8 liters, to dispense 5 to 6 liters of food.

8. The method of transporting bees of claim 4, wherein the temperature, the relative humidity, and the concentrations of O₂ and CO₂ are controlled in the refrigerated container and the speed of the wind incident on the transport boxes is fixed by means of wooden panels and deflectors.

9. The method of transporting bees of claim 8, wherein the transport temperature in the container is set within the range of 4 to 7° C.

10. The method of transporting bees of claim 9, wherein the relative humidity must be maintained at around 65%.

11. The method of transporting bees of claim 10, wherein a noise inside the transport box (20) is less than 94 dB.

12. The method of transporting bees of claim 4, wherein the transport of the transport boxes (20) from a seaport of arrival to the destination is carried out in a flatbed truck in the same refrigerated container (30) if it is autonomous or by means of a refrigerated truck if it is not.

13. The method of transporting bees of claim 4, wherein the transport of the transport boxes (20) from a port of arrival to the destination is carried out by closed trucks, ideally refrigerated, taking care to maintain the temperature between 5 and 15° C., the relative humidity close to 65%, and CO2 and O2 concentrations at atmospheric levels.

14. The method of transporting bees of claim 4, wherein after one or two days in the field inside breeding chambers or nucleus boxes, the feeder is removed from the hive and health checks are carried out to check the condition of the colony.

15. The method of transporting bees of claim 14, wherein one week after unloading, the colony recovers its productive activity (queen laying and nectar accumulation).

16. A transport box (20) that allows the export of live bees in hibernation, by sea comprising:
a body (21); and
a cover (22) of the same geometry and larger than the body (21) to cover all the side walls of the body (21), with two ventilation openings (23) arranged on two opposite side walls of the body (21), at least one floor (24) arranged to cover the lower part of the transport box (20),
the body (21) being where the bees are collected.

17. The transport box (20) of claim 16 comprising a square cross section formed by the body (21) and the cover (22), wherein the body (21) comprises at least two ventilation openings (23), preferably arranged opposite each other, and the floor (24), and at the top of the body (21) there is an opening (25) for placing a feeder.
